(19) United States
(12) Patent Application Publication
(10) Pub. No.: US 2017/0268930 A1
(43) Pub. Date: Sep. 21, 2017

(54) Spectroscopic Apparatus and Method

(71) Applicant: Qrometric Limited, Hove East Sussex (GB)

(72) Inventors: Edward Maxwell Hawes, Hove East Sussex (GB); Timothy Freegarde, Highfield Southampton (GB); Matthew Himsworth, Highfield Southampton (GB)

(21) Appl. No.: 15/532,247

(22) PCT Filed: Dec. 1, 2015
(86) PCT No.: PCT/EP2015/078232

§ 371 Date: Jun. 1, 2017

(30) Foreign Application Priority Data
Dec. 2, 2014 (GB) 1421416.7

(51) Int. Cl. G01J 3/433; G01J 3/40

(52) U.S. Cl. CPC G01J 3/4338; G01J 3/40

(57) ABSTRACT

There is described an apparatus (2) for measuring an amount of an analyte in a mixture. In one example, the apparatus (2) has a laser source (6) for generating a frequency-modulated laser beam (22). A cavity (36) receives the frequency-modulated laser beam (22) and a photodetector (46) obtains an intensity signal indicative of an interaction between the frequency-modulated laser beam (22) and the mixture. The apparatus (2) has a first demodulator (76) for producing a first demodulation signal. A frequency locking arrangement uses the first demodulation signal to lock a carrier frequency of the frequency-modulated laser beam (22) and a mode of the cavity (36) to each other. The apparatus has a second demodulator (50) for producing a second demodulation signal and for generating, on the basis of the second demodulation signal, an output indicative of the amount of the analyte in the mixture. Other apparatus and methods are described.

### TECHNICAL FIELD

The present invention relates to a spectroscopic apparatus and method.

### BACKGROUND

Spectroscopic apparatus and methods for the measurement of the amount of an analyte in a mixture are known.

In a known spectroscopic method, absorption of certain characteristic wavelengths of light by an analyte can be exploited to ascertain the amount of the analyte in a mixture. In the known spectroscopic method, a laser with an initial intensity is passed through the mixture and the intensity of light transmitted by the mixture is measured. This allows the absorption characteristics of the mixture to be obtained and, from this, the amount of the analyte in the mixture to be determined.

It is in general desirable to provide a spectroscopic apparatus and method which provides for a high signal-to-noise ratio and which has simplified and/or more effective processing.

### SUMMARY

According to a first aspect of the present invention, there is provided an apparatus for measuring an amount of an analyte in a mixture, the apparatus comprising:

a laser source for generating a frequency-modulated laser beam which is frequency modulated at a modulation frequency;

a cavity arranged to receive the frequency-modulated laser beam;

a photodetector for obtaining an intensity signal indicative of an interaction between the frequency-modulated laser beam and the mixture;

a first demodulator for producing a first demodulation signal by demodulating the intensity signal;

a frequency locking arrangement arranged to use the first demodulation signal to lock a carrier frequency of the frequency-modulated laser beam and a mode of the cavity to each other; and

a second demodulator for producing a second demodulation signal by demodulating the intensity signal and for generating, on the basis of the second demodulation signal, an output indicative of the amount of the analyte in the mixture.

Producing the first demodulation signal and the second demodulation signal by demodulating the same intensity signal enables the transmission of the laser beam through the mixture, the laser detuning and the laser bandwidth to be controlled and processed using a single modulation signal. Accordingly, processing and control of examples of the spectroscopic apparatus can be more straightforward than known spectroscopic apparatus which are configured to modulate a laser beam at multiple modulation frequencies, for example using more than one modulator.

In this example, the apparatus comprises a cavity arranged to receive the frequency-modulated laser beam. Use of a cavity increases the path length of the frequency-modulated laser beam, which improves the sensitivity of the measurement of the amount of the analyte in the mixture. For example, locking the carrier frequency of the frequency-modulated laser beam and a mode of the cavity to each other may minimise the wavelength drift and linewidth of the laser beam which, in examples, may improve the measurement sensitivity.

In examples, demodulation of the intensity signal in the frequency domain rather than temporal domain avoids laser switching, noise transients which are synchronous with the demodulation of the intensity signal, and dark periods which do not contribute to the final output which is indicative of the amount of the analyte in the mixture.

The mixture may be for example a single analyte in a single “background” or “matrix” material, or a single analyte in a mixture of background materials, or plural analytes in a single background material, or plural analytes in a mixture of background materials. The background material may be for example one or more gases.

In an embodiment, the first demodulator is arranged to produce the first demodulation signal by demodulating the intensity signal at the modulation frequency. The second demodulator in an embodiment is arranged to produce the second demodulation signal by demodulating the intensity signal at a multiple of the modulation frequency. A multiple of the modulation frequency may be a non-integer multiple or an integer multiple, i.e. a harmonic, of the modulation frequency. For example, the second demodulator may be arranged to produce the second demodulation signal by demodulating the intensity signal at twice the modulation frequency. As explained above, demodulating the same intensity signal to produce both the first demodulation signal and the second demodulation signal allows a simpler and, in examples cheaper, apparatus to be used than a known apparatus.

In an embodiment, the frequency locking arrangement is arranged to adjust the carrier frequency of the frequency-modulated laser beam to correspond to a desired cavity mode. Alternatively or additionally, the frequency locking arrangement may be arranged to adjust the mode of the cavity to correspond to a desired carrier frequency of the frequency-modulated laser beam.

In an embodiment, the frequency locking arrangement is arranged to lock at least one of (i) the carrier frequency of the frequency-modulated laser beam and (ii) the mode of the cavity to a mode of the cavity that has a frequency which is closest to a frequency of a radiative transition of the analyte.

In an embodiment, the frequency locking arrangement comprises a device for changing a length of the cavity. This may be used in examples to alter the cavity length to lock the mode of the cavity and the carrier frequency of the frequency-modulated laser beam to each other.

In an embodiment, the cavity is one of a plurality of cavities, each of the plurality of cavities being for receiving the frequency-modulated laser beam. In examples, a plurality of cavities may be used to respond to different levels of analyte concentration.

In an embodiment, the spectroscopic apparatus comprises a micro-resonator. In examples, use of a micro-resonator means that the spectroscopic apparatus can be produced with a reduced size and/or cost, and is typically more robust, compared to a known apparatus. The micro-resonator may be a micro-ring resonator, for example.

In an embodiment, the micro-resonator is one of a plurality of micro-resonators, each of the micro-resonators being for increasing the intensity of the frequency-modulated laser beam. Saturation effects may be mitigated using such a plurality of micro-resonators.

In an embodiment, the intensity signal that the photodetector is arranged to obtain is indicative of an interaction between the mixture and an evanescent field arising outside the cavity from the frequency-modulated laser beam. For example, an evanescent field may be produced when the frequency-modulated laser beam within the cavity is incident on a boundary between an interior of the cavity and an external environment. The evanescent field in examples is incident on, and interacts with, the mixture, which is outside the cavity in such examples.

In a different embodiment, the cavity may be for containing the mixture in use. The cavity of this embodiment may be provided by for example a Fabry-Perot etalon. In such an embodiment, the intensity signal the photodetector is arranged to obtain may be indicative of an intensity of the frequency-modulated laser beam having passed through the mixture.

As is clear from the above, many different cavity types are suitable for use in the spectroscopic apparatus, providing abundant design freedom for customisation of the apparatus by a user.

In an embodiment, the output indicative of the amount of the analyte in the mixture is indicative of a concentration of the analyte in the mixture. For example, the output may be indicative of a proportion of the analyte compared to one or more other components of the mixture.

A further embodiment relates to a hygrometer comprising an apparatus according to examples described above. The hygrometer may be used to measure the amount of water in a mixture, for example in an ambient environment or a particular mixture sample.

According to a second aspect of the present invention, there is provided a spectroscopic method for measuring an amount of an analyte in a mixture, the method comprising:

generating a frequency-modulated laser beam which is frequency modulated at a modulation frequency;

passing the frequency-modulated laser beam into a cavity;

obtaining an intensity signal indicative of an interaction between the frequency-modulated laser beam and the mixture;

producing a first demodulation signal by demodulating the intensity signal;

locking a carrier frequency of the frequency-modulated laser beam and a mode of the cavity to each other using the first demodulation signal;

producing a second demodulation signal by demodulating the intensity signal; and

generating, on the basis of the second demodulation signal, an output indicative of the amount of the analyte in the mixture.

In an embodiment, the producing the first demodulation signal comprises demodulating the intensity signal at the modulation frequency. In an embodiment, the producing the second demodulation signal comprises demodulating the intensity signal at a multiple of the modulation frequency, for example twice the modulation frequency.

In an embodiment, the locking a carrier frequency of the frequency-modulated laser beam and a mode of the cavity to each other comprises adjusting the carrier frequency of the frequency-modulated laser beam to correspond to a desired cavity mode. In an embodiment, the locking a carrier frequency of the frequency-modulated laser beam and a mode of the cavity to each other may alternatively or additionally include adjusting the mode of the cavity to correspond to a desired carrier frequency of the frequency-modulated laser beam.

In an embodiment, the passing the frequency-modulated laser beam into a cavity comprises passing the frequency-modulated laser beam into a cavity adjacent to the mixture, the obtaining an intensity signal including obtaining an intensity signal indicative of an interaction between the mixture and an evanescent field outside the cavity, the evanescent field produced by interaction of the frequency-modulated laser beam with the cavity.

In a different embodiment, the passing the frequency-modulated laser beam into a cavity comprises passing the frequency-modulated laser beam through a cavity containing the mixture, the obtaining an intensity signal including obtaining an intensity signal indicative of an intensity of the frequency-modulated laser beam having passed through the mixture.

In an embodiment, the locking the carrier frequency of the frequency-modulated laser beam and the mode of the cavity to each other is carried out at substantially the same time as the generating, on the basis of the second demodulation signal, the output indicative of the amount of the analyte in the mixture. This provides for more efficient control than for example a known method in which the laser beam is locked to a particular carrier frequency either before or after a measurement of the amount of the analyte present is carried out.

In an embodiment, the locking the carrier frequency of the frequency-modulated laser beam and the mode of the cavity to each other comprises locking at least one of (i) the carrier frequency of the frequency-modulated laser beam and (ii) the mode of the cavity to a mode of the cavity that has a frequency which is closest to a frequency of a radiative transition of the analyte. In an alternative embodiment, the locking the carrier frequency of the frequency-modulated laser beam and the mode of the cavity to each other comprises locking at least one of (i) the carrier frequency of the frequency-modulated laser beam and (ii) the mode of the cavity to a mode of the cavity that has a frequency other than a frequency which is closest to a frequency of a radiative transition of the analyte.

In an embodiment, the spectroscopic method comprises:

locking the carrier frequency of the frequency-modulated laser beam to a frequency at which substantially none of the frequency-modulated laser beam is absorbed by the analyte when the frequency-modulated laser beam is passed through the mixture;

passing the frequency-modulated laser beam into the cavity;

obtaining a second intensity signal indicative of an interaction between the frequency-modulated laser beam and the mixture;

producing a third demodulation signal by demodulating the second intensity signal; and

generating, on the basis of the third demodulation signal, an output indicative of an amount of the frequency-modulated laser beam which is absorbed by one or more components of the mixture other than the analyte.

The output obtainable with this embodiment, which is indicative of the amount of the frequency-modulated laser beam which is absorbed by one or more components of the mixture other than the analyte, may be used for calibration purposes.

In an embodiment, the third demodulation signal is produced by demodulating the intensity signal at a multiple of the modulation frequency, for example at twice the modulation frequency.

In an embodiment, the output indicative of the amount of the analyte in the mixture is indicative of a concentration of the analyte in the mixture. For example, the output may be indicative of a proportion of the analyte compared to one or more other components of the mixture.

In an embodiment, the mixture comprises at least one gas. The analyte itself may be a gas, for example water in the form of water vapour. Therefore, the spectroscopic method may be used for example to determine an amount of water vapour in a gas or a mixture of gases, including air for example.

In an embodiment, the analyte comprises one or more of: oxygen, hydrogen fluoride or sulphur dioxide. In a further embodiment, a component of the mixture other than the analyte comprises one or more of: air, methane, hydrogen, carbon dioxide or sulphur hexafluoride. For example, the component of the mixture other than the analyte may be one or more “matrix” or background materials.

In an embodiment, the frequency-modulated laser beam is frequency modulated at a plurality of modulation frequencies, the plurality of modulation frequencies including the modulation frequency. In this embodiment, the intensity signal may be demodulated at each of the plurality of modulation frequencies. Alternatively, the intensity signal may be demodulated at a frequency other than the plurality of modulation frequencies. In an embodiment, the frequency-modulated laser beam is frequency modulated with a pseudorandom modulation signal.

In an embodiment, the spectroscopic method comprises producing one or more further demodulation signals by demodulating the intensity signal at one or more further frequencies. In this embodiment, the one or more further frequencies may each be more than twice the modulation frequency

According to a third aspect of the present invention, there is provided an apparatus for measuring an amount of an analyte in a mixture, the apparatus comprising:

a laser source for generating a frequency-modulated laser beam which is frequency modulated at a modulation frequency;

a photodetector for obtaining an intensity signal indicative of an intensity of the frequency-modulated laser beam having passed through the mixture;

a first demodulator for producing a first demodulation signal by demodulating the intensity signal;

a frequency locking arrangement arranged to use the first demodulation signal to lock a carrier frequency of the frequency-modulated laser beam and a desired frequency to each other; and

a second demodulator for producing a second demodulation signal by demodulating the intensity signal and for generating, on the basis of the second demodulation signal, an output indicative of the amount of the analyte in the mixture.

According to a fourth aspect of the present invention, there is provided a spectroscopic method for measuring an amount of an analyte in a mixture, the method comprising:

generating a frequency-modulated laser beam which is frequency modulated at a modulation frequency;

passing the frequency-modulated laser beam through the mixture;

obtaining an intensity signal indicative of an intensity of the frequency-modulated laser beam having passed through the mixture;

producing a first demodulation signal by demodulating the intensity signal;

locking a carrier frequency of the frequency-modulated laser beam and a desired frequency to each other using the first demodulation signal;

producing a second demodulation signal by demodulating the intensity signal; and

generating, on the basis of the second demodulation signal, an output indicative of the amount of the analyte in the mixture.

In these aspects, in contrast to the previous aspects, no cavity for the frequency-modulated laser beam is provided. Other arrangements may be used instead.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows schematically an example spectrum of a frequency-modulated laser beam;

FIG. 2 shows schematically an example of a spectroscopic apparatus for measuring an amount of an analyte in a mixture according to an embodiment of the present invention;

FIG. 3 shows schematically an illustrative example of the principles of operation of an example Fabry-Perot etalon;

FIG. 4 shows schematically an example spectroscopic apparatus according to an embodiment of the present invention comprising multiple micro-resonators; and

FIG. 5 shows schematically an example of a spectroscopic apparatus for measuring an amount of an analyte in a mixture according to a further embodiment of the present invention.

### DETAILED DESCRIPTION

In a spectroscopic method according to an example, a frequency-modulated laser beam is passed into a cavity. An intensity signal is used to lock a carrier frequency of the laser and a mode of the cavity to each other and also to provide a measure of the amount of an analyte in a mixture. Use of a cavity in examples improves design compactness as it allows the optical path length through the analyte to be extended without having to increase the physical size of the apparatus. Furthermore, a spectroscopic apparatus with a cavity may also be highly accurate, robust and low cost, particularly in the case of the cavity being a so-called “micro-cavity”. For example, use of the spectroscopic apparatus with a high finesse cavity can provide signal enhancement as well as a reduction in 1/f noise. (The finesse of an optical resonator or cavity may be defined as its free spectral range divided by the (full width at half-maximum) bandwidth of its resonances.)

The spectroscopic apparatus according to embodiments can be used with a variety of different cavities, including but not limited to those of a linear type, such as the Fabry-Perot etalon, and wave-guided micro-cavities, i.e. micro-resonators, which can be constructed on a sub-millimetre scale. Cavities for use with the apparatus may be hollow or otherwise, and may or may not contain the mixture, as discussed further below.

In one example, a single modulation frequency is used; in other examples, more than one modulation frequency may be used. The carrier frequency of the laser beam is locked to a cavity mode corresponding to the central frequency of an absorption feature of the analyte of interest in this example. However, in other examples, the carrier frequency may be locked to other cavity modes. In further embodiments, the mode of the cavity may be locked to the carrier frequency of the laser beam, for example by altering the cavity length to adjust the modes of the cavity until the carrier frequency of the laser beam corresponds with a cavity mode.

The beat note at the modulation frequency, ωₘ, also referred to as the 1f term, is used to lock the carrier frequency of the laser beam in this example. In an example the known Pound-Drever-Hall technique may be used for this locking of the carrier frequency, though alternative locking techniques can be used. The beat note at twice the modulation frequency, 2ωₘ, and a quarter wavelength out of phase with the input field, also referred to as the 2f quadrature term, has a magnitude proportional to the analyte concentration. Therefore, measuring the 2f term allows the amount of analyte in the mixture to be determined. In other examples, the intensity signal may be demodulated at other frequencies to lock the carrier frequency and the mode of the cavity to each other and/or to provide the output indicative of the amount of analyte.

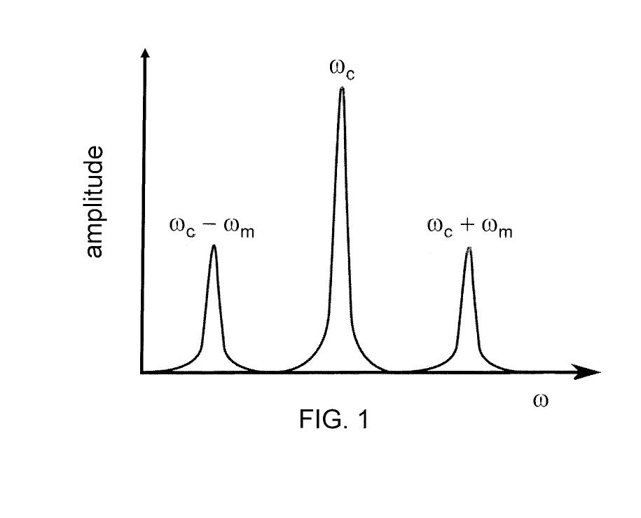

In more detail, in the example spectroscopic method of FIG. 1, a frequency-modulated laser beam is generated by performing active frequency modulation of a laser diode using a signal generator. In other examples, a laser beam may be generated first and then frequency modulated, for example using an acousto-optic modulator or an electro-optic modulator. For example, an all-fibre electro-optic modulator may be used to frequency modulate the laser beam. Frequency-modulation of the laser beam enables stabilisation of the laser frequency and hence the laser wavelength while also rejecting low frequency noise.

The electric field generated by the laser beam before frequency modulation can be represented by the real part of:

E(x,t)=E₀e^{i(ωt-kx)}

where E(x, t) is the electric field at position x at time t, E₀ is the amplitude of the electric field, i is the imaginary unit, ω is the frequency of the laser and kx is the phase angle.

Frequency modulating the laser injection current sinusoidally at a modulation frequency ωₘ produces an electric field of the form:

E(t)=E₀(1+M sin(ωₘt+ψ))e^{i(ω}^{_{c}}^{t+β sin(ω}^{ₘ}^{t))}

where the M sin(ωₘt+ω) term is an amplitude modulation term and an instantaneous phase of the electric field is (ωₘt+β sin(ωₘt)).

After using the Jacobi-Anger identity, this equation may be rewritten as:

$$E ( t ) = {E}_{0} ( 1 + M sin ( {ω}_{m} t + ψ ) ) {\sum }_{n = - ∞}^{∞} {J}_{n} ( β ) {e}^{i ( {ω}_{c} + n {ω}_{m} ) t}$$

where Jₙ(β) is the n^{th} Bessel function of the first kind. This equation shows that the Fourier transform of the modulated electric field will contain an infinite number of frequency components, which in this case are sideband pairs.

In examples, the components of order |n|>1 are insignificant, reducing this equation to:

$$E ( t ) = {E}_{0} ( 1 + M sin ( {ω}_{m} t + ψ ) ) ( - \frac{β}{2} {e}^{i ( {ω}_{c} - {ω}_{m} ) t} + {e}^{i {ω}_{c} t} + \frac{β}{2} {e}^{i ( {ω}_{c} + {ω}_{m} ) t} )$$

where β is the modulation amplitude.

FIG. 1 shows schematically an example of the spectrum of the Fourier transform of the above, illustrating the carrier frequency ω_{c} and two first-order side-bands at ω_{c}+ωₘ and ω_{c}−ωₘ. The presence of a mixture comprising an absorbing analyte in the path of the frequency-modulated laser beam leads to the introduction of a transmission function:

Tₙ(ω)=e^{(-δ}^{ₙ}^{-iφ}^{ₙ}⁾

where δₙ is the amplitude attention and φₙ is the phase shift caused by the analyte at angular frequency ω_{c}+nωₘ.

Introducing the transmission function into the expression for the electric field of the frequency-modulated laser beam and squaring the electric field to obtain the intensity, it follows that:

$$I ( t ) = {{I}_{0} ( 1 + M sin ( {ω}_{m} t + ψ ) )}^{2} {\sum }_{n = - ∞}^{∞} {\sum }_{k = - ∞}^{∞} {T}_{n} ( ω ) {T}_{k}^{*} ( ω ) {J}_{n} ( β ) {J}_{k} ( β ) {e}^{i ( n - k ) {ω}_{m} t}$$

where I(t) is the intensity of the frequency-modulated laser beam having passed through the mixture and where * indicates taking the complex conjugate of a term.

In an example in which β<<1, and in which the amplitude modulation M is omitted for simplicity, the higher order terms can be omitted to obtain:

$$I ( t ) = {T}_{- 1} {T}_{- 1}^{*} {J}_{- 1}^{2} + {T}_{0} {T}_{0}^{*} {J}_{0}^{2} + {T}_{1} {T}_{1}^{*} {J}_{1}^{2} + {T}_{- 1} {T}_{0}^{*} {J}_{- 1} {J}_{0} {e}^{- i {ω}_{m} t} + {T}_{- 1} {T}_{1}^{*} {J}_{- 1} {e}^{- 2 i {ω}_{m} t} + {T}_{0} {T}_{- 1}^{*} {J}_{0} {J}_{- 1} {e}^{i {ω}_{m} t} + {T}_{0} {T}_{1}^{*} {J}_{0} {J}_{1} {e}^{- i {ω}_{m} t} + {T}_{1} {T}_{- 1}^{*} {J}_{1} {J}_{- 1} {e}^{2 i {ω}_{m} t} + {T}_{1} {T}_{0}^{*} {J}_{1} {J}_{0} {e}^{i {ω}_{m} t}$$

The final six terms of this equation involve summations of sinusoidal terms at the modulation frequency, ωₘ, and at twice the modulation frequency, 2ωₘ. These terms can be extracted through a series of mixing and filtering. This may be achieved using for example a phase sensitive detector as will be appreciated by the skilled person and as described in more detail below.

After some manipulation, the terms at the modulation frequency and at twice the modulation frequency may be expressed as:

$$I ( t ) {\vert}_{{ω}_{m}} = {I}_{0} ( β Re ( A ) cos ( {ω}_{m} t ) - β Im ( A ) sin ( {ω}_{m} t ) )$$

$$I ( t ) {\vert}_{2 {ω}_{m}} = {I}_{0} ( \frac{{β}^{2}}{2} Re ( {T}_{- 1} {T}_{- 1}^{*} ) cos ( 2 {ω}_{m} t ) - \frac{{β}^{2}}{2} Im ( {T}_{- 1} {T}_{- 1}^{*} ) sin ( 2 {ω}_{m} t ) )$$

where A=−T₀T₋₁*+T₁T₀* and Re and Im refer to real and imaginary components respectively.

If the additional amplitude modulation M is included and if β, M<<1, the electric field of the frequency-modulated laser beam is given by:

$$E ( t ) = {E}_{0} \{ {T}_{0} {e}^{i {ω}_{0} t} + [ \frac{{T}_{1} β}{2} + \frac{M}{2 i} {T}_{0} {e}^{i ψ} ] {e}^{i ( {ω}_{0} + {ω}_{m} ) t} - [ \frac{{T}_{- 1} β}{2} + \frac{M}{2 i} {T}_{0} {e}^{- i ψ} ] {e}^{i ( {ω}_{0} - {ω}_{m} ) t} \}$$

which corresponds to an intensity of:

$$I ( t ) = {I}_{0} \{ \frac{{β}^{2}}{4} {T}_{- 1} {T}_{- 1}^{*} + {T}_{0} {T}_{0}^{*} + \frac{{β}^{2}}{4} {T}_{1} {T}_{1}^{*} + α {e}^{i {ω}_{m} t} + {α}^{*} {e}^{- i {ω}_{m} t} + γ {e}^{2 i {ω}_{m} t} + {γ}^{*} {e}^{- 2 i {ω}_{m} t} \}$$

where I₀ contains a term representing the detector efficiency, and:

$$α = \frac{β}{2} {T}_{1} {T}_{0}^{*} - \frac{β}{2} {T}_{0} {T}_{1}^{*} - {ie}^{i ψ} {MT}_{0} {T}_{0}^{*}$$

$$γ = \frac{1}{2} {ie}^{i ψ} M β {T}_{0} {T}_{- 1}^{*} - \frac{{β}^{2}}{4} {T}_{1} {T}_{- 1}^{*} - \frac{1}{2} {ie}^{i ψ} M β {T}_{1} {T}_{0}^{*}$$

Using Euler's identity gives:

$$I ( t ) = {I}_{0} \{ \frac{{β}^{2}}{4} {T}_{- 1} {T}_{- 1}^{*} + {T}_{0} {T}_{0}^{*} + \frac{{β}^{2}}{4} {T}_{1} {T}_{1}^{*} + 2 Re ( α ) cos ( {ω}_{m} t ) - 2 Im ( α ) sin ( {ω}_{m} t ) + 2 Re ( γ ) cos ( 2 {ω}_{m} t ) - 2 Im ( γ ) sin ( 2 {ω}_{m} t )$$

Assuming that |δ₀−δ_{±1}|<<1 and |φ₀−φ_{±1}|<<1 so that e^{x}≈1+x, the amplitudes of the ωₘ and 2ωₘ terms may be written in terms of δ and φ to give:

$$I ( t ) \approx {I}_{0} \{ \frac{{β}^{2}}{4} {T}_{- 1} {T}_{- 1}^{*} + {T}_{0 } {T}_{0}^{*} + \frac{{β}^{2}}{4} {T}_{1} {T}_{1}^{*} + [ β ( {δ}_{- 1} - {δ}_{1} ) + 2 M ( 1 - 2 {δ}_{0 } ) sin ( ψ ) ] cos ( {ω}_{m} t ) - [ β ( 2 {φ}_{0} - {φ}_{- 1} - {φ}_{1} ) - 2 M ( 1 - 2 {δ}_{0} ) cos ( ψ ) ] sin ( {ω}_{m} t ) + 2 [ \frac{M β}{2} ( {δ}_{- 1} - {δ}_{1} ) sin ( ψ ) - \frac{{β}^{2}}{4} ( 1 - {δ}_{1} - {δ}_{- 1} ) + \frac{M β}{2} cos ( ψ ) ( 2 {φ}_{0} - {φ}_{1} - {φ}_{- 1} ) ] cos ( 2 {ω}_{m} t ) - 2 [ \frac{M β}{2} ( 2 {φ}_{0} - {φ}_{1} - {φ}_{- 1} ) sin ( ψ ) - \frac{{β}^{2}}{4} ( {φ}_{- 1} - {φ}_{1} ) + \frac{M β}{2} ( {δ}_{1} - {δ}_{- 1} ) cos ( ψ ) ] sin ( 2 {ω}_{m} t ) \} .$$

This intensity signal can be demodulated at the modulation frequency to produce a first demodulation signal (which may be referred to as “1f detection”). This intensity signal can also be demodulated at twice the modulation frequency to produce a second demodulation signal (which may be referred to as “2f detection”). In other examples, the intensity signal can be demodulated at other frequencies to produce the first and/or second demodulation signals. For example, the intensity signal may be demodulated at a multiple, which may be an integer or non-integer multiple, of the modulation frequency. Alternatively, the intensity signal may be demodulated at a sum or difference of certain frequencies, for example certain multiples of the modulation frequency.

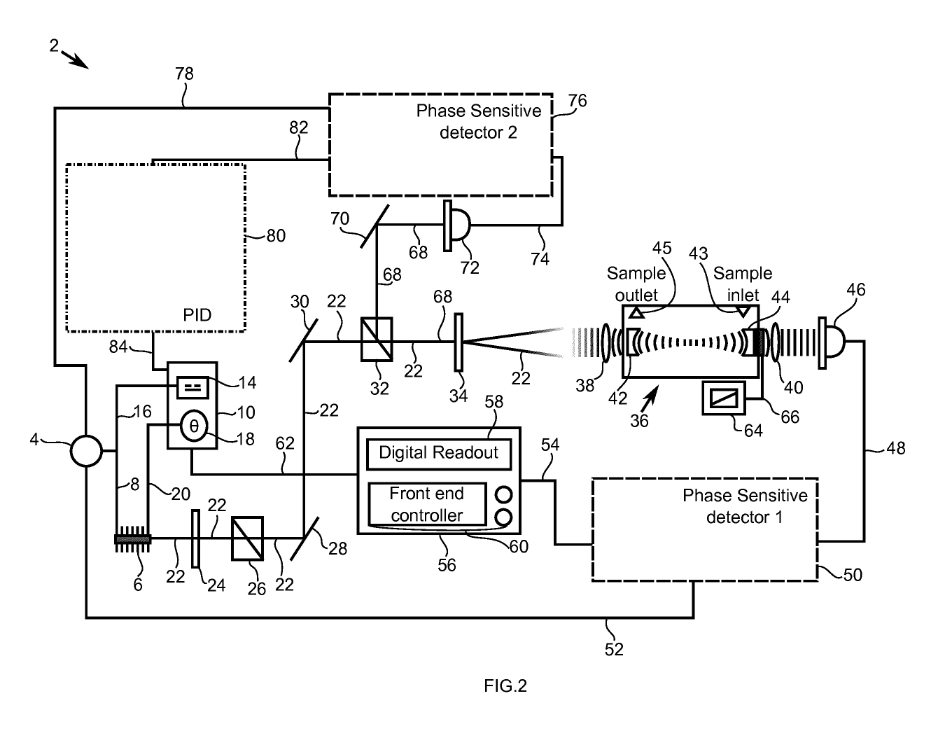

A schematic illustration of an example spectroscopic apparatus 2 for measuring an amount of an analyte in a mixture according to an embodiment is shown in FIG. 2. A voltage-controlled oscillator 4 is used to modulate the current supplied to a laser diode 6 via an electrical connection 8, though the current may be modulated by other means, such as a function generator, in other examples. In an example, the injection current is modulated at a frequency of approximately 100 kilohertz (kHz), though other modulation frequencies may be used, depending on for example the particular application of the method and apparatus.

The measurement of a small change of an absorbing signal on top of a large background signal requires careful choice of a characteristic absorption frequency to be probed, coupled with a mechanical set-up that maximises signal strength. The voltage-controlled oscillator 4 supplies a current to the laser diode 6 with a modulation frequency which is selected to generate a frequency-modulated laser beam with the desired carrier frequency. For example, the carrier frequency of the frequency-modulated laser beam may be of the order of hundreds of terahertz (THz) whereas the current supplied by the voltage-controlled oscillator 4 may be modulated at a frequency of the order of hundreds of kHz. In this example, the carrier frequency of the frequency-modulated laser beam corresponds to a radiative transition of an analyte to be detected.

In the case of trace water detection for example, the relatively strong transition from the ground vibrational state to the first excited vibrational state of the combination band, represented in spectroscopic notation by (1, 0, 1)←(0, 0, 0), may be used. In Mulliken notation this is an A₁→B₂ type transition.

The laser diode 6 in this example is a butterfly packaged laser diode but other types of laser diode or indeed lasers other than laser diodes could be used instead.

A tuning apparatus 10 is used to control the coarse and fine tuning of the injection current. In the example of FIG. 2, the tuning apparatus 10 comprises a laser current driver 14 which provides a DC bias to drive the laser diode 6 via an electrical connection 16. The voltage-controlled oscillator 4 provides an AC signal at the modulation frequency via an electrical connection 8. The tuning apparatus 10 in this example also comprises a temperature control 18 connected to the laser diode 6 via an electrical connection 20. In other examples, there may be no tuning apparatus to adjust the injection current or the tuning apparatus may comprise different components from the tuning apparatus 10 of FIG. 2.

The frequency-modulated laser beam 22 generated by the laser diode 6 is incident on an optical arrangement in the example of FIG. 2. The optical arrangement may be used for example to adjust the phase, polarisation and/or beam waist diameter of the frequency-modulated laser beam 22. In other examples, the frequency-modulated laser beam does not pass through an optical arrangement and is instead passed directly through the mixture.

In FIG. 2, the optical arrangement includes a half-wave plate 24, a first polarising beam splitter 26, a first mirror 28, a second mirror 30, a second polarising beam splitter 32 and a quarter-wave plate 34. The optical arrangement guides the frequency-modulated laser beam 22 so it is incident on a cavity 36.

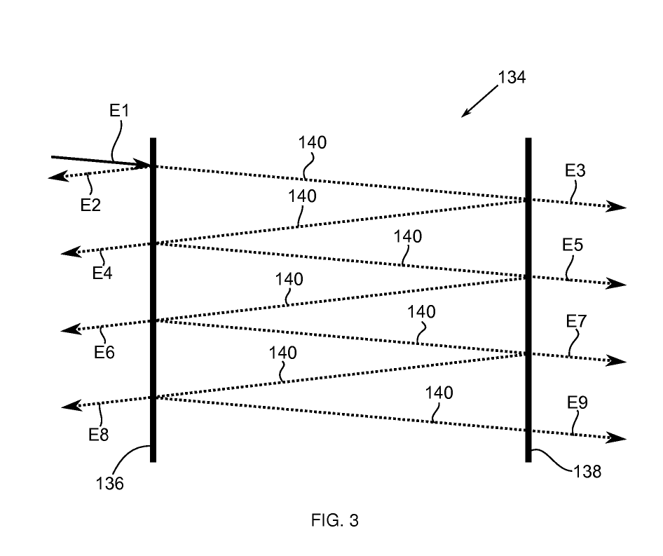

The cavity 36 of the example spectroscopic apparatus 2 of FIG. 2 is a confocal cavity. A first lens 38 and a second lens 40 are arranged on either side of the cavity 36. The first and second lenses 38, 40 are configured so that the focus of an incident beam is at the centre of the cavity 36. The cavity 36 also comprises a first mirror 42 and a second mirror 44, located on opposite sides of the cavity 36, with the first mirror 42 arranged on the same side of the cavity 36 as the first lens 38 and the second mirror 44 arranged on the same side of the cavity 36 as the second lens 40. In the example of FIG. 2, the first and second mirrors 42, 44 have a radius of curvature which corresponds to the radius of curvature of the field of the frequency-modulated laser beam 22 which is incident on the first lens 38. In other examples, the cavity may be asymmetric, with mirrors with radii of curvature which do not correspond to the radius of curvature of the field, such that the beam waist of the frequency-modulated laser beam 22 is not at the mid-point of the cavity. An example cavity for use in the spectroscopic apparatus 2 is described in more detail below with reference to FIG. 3.

A sample of the mixture can enter the cavity 36 via a sample inlet 43 and exit the cavity 36 via a sample outlet 45. Thus, in the example of FIG. 2, the mixture is contained within the cavity. However, in other examples of the spectroscopic apparatus, such as those with a solid cavity and discussed in more detail below, the mixture may not be within the cavity. The mixture may instead be in proximity to or adjacent to the cavity, for example such that the mixture is incident on or in contact with a surface of the cavity or a surface of a container for the cavity. (Here, with reference to the use of a “solid cavity”, it should be borne in mind that the cavity is for containing the laser beam 22, and therefore may be “solid” as far as the mixture is concerned but translucent, or “a cavity”, as far as the laser beam 22 is concerned.)

The frequency-modulated laser beam 22 of FIG. 2 enters the cavity 36, passing through the first lens 36 and the first mirror 42. The frequency-modulated laser beam 22 then passes through the mixture which is contained within the cavity 36. At least a portion of the frequency-modulated laser beam 22 exits the cavity 36 through the second mirror 44 and the second lens 40 and is incident on a first photodetector 46. A different portion of the frequency-modulated laser beam 22 may be reflected by the second mirror 44, and remain within the cavity or exit the cavity through the first mirror 42 and the first lens 38 as described below with reference to FIG. 3.

The first photodetector 46 converts the incident portion of the frequency-modulated laser beam 22 into an intensity signal which is indicative of an interaction between the frequency-modulated laser beam 22 and the mixture. In this example, the intensity signal is indicative of an intensity of the frequency-modulated laser beam 22 having passed through the mixture; in other examples, the intensity signal may be indicative of a different interaction between the frequency-modulated laser beam 22 and the mixture. In the example of FIG. 2, the intensity signal is an electronic signal, which is transferred via an electrical connection 48 to a first phase sensitive detector 50, which receives an input reference voltage via an electrical connection 52 from the voltage-controlled oscillator 4. The first phase sensitive detector 50 in this example demodulates the intensity signal at twice the modulation frequency to produce a second demodulation signal and generates, on the basis of the second demodulation signal, an output indicative of the amount of the analyte in the mixture. As explained above, in other examples, the intensity signal may be demodulated at a different frequency, for example other integer or non-integer multiples of the modulation frequency, to obtain the second demodulation signal. Phase sensitive detection in an example spectroscopic apparatus is described in more detail below.

In this example, the analyte is water vapour and the mixture is a mixture of air and water vapour. Therefore, the output obtained in this example is indicative of the amount of water vapour present, i.e. the humidity within the cavity 36. In the example of measuring humidity, water is often considered to be a contaminant in various industrial process gases, particularly those used in semiconductor and solid state lighting fabrication, battery production, etc. Cost effective measurement of trace analytes lower than parts-per-billion concentration is desirable in such cases. For example, in the case of water, the drier the matrix gas, the higher the yield and performance of the resulting products in various manufacturing processes. This means that for example faster micro-processors, brighter LEDs, and more efficient batteries can be produced, with a higher yield. Other industrial processes, including for example the control of fuel-cells, require accurate measurement of high concentration humidity, for example near saturation. In summary, improved control of humidity can yield enhanced efficiency in many industrial and manufacturing applications.

As will be appreciated by the skilled person, the spectroscopic method can also be used to measure other analytes in other mixtures. For example, the spectroscopic method may be used to measure methane in air or ammonia in bioreactor outgassing. In further examples, the spectroscopic method may be used to detect compounds in human breath which are indicative of certain diseases. For example, the presence of nitrogen monoxide (NO) in human breath may be symptomatic of asthma and the presence of formaldehyde in human breath may suggest breast cancer.

In further examples, the analyte comprises one or more of: oxygen, hydrogen fluoride or sulphur dioxide. In examples, a component of the mixture other than the analyte, for example one or more “matrix” or background components, comprises one or more of: air, methane, hydrogen, carbon dioxide or sulphur hexafluoride.

In examples, the spectroscopic method may be used to monitor the humidity of the environment surrounding a high voltage gas insulated switchgear with sulphur hexafluoride as the insulator. If the sulphur hexafluoride comes into contact with water, it may react to form hydrogen fluoride, sulphur dioxide and sulphuric acid which can corrode the switchgear. Therefore, monitoring of the environmental humidity using the spectroscopic method and reduction of the humidity as necessary can be used to reduce corrosion of the switchgear in examples.

Returning to the example of FIG. 2, the output of the first phase sensitive detector 50 in this example is transferred via an electrical connection 54 to a front end panel 56, which provides an output indicative of the amount of the analyte in the mixture via a digital readout 58. The front end panel 56 also includes a front end controller 60, connected via an electrical connection 62 to the tuning apparatus 10, which may be used to set various parameters of the spectroscopic apparatus 2. For example, the front end controller 60 may be used to modulate or control the current supplied to the laser diode 6 by the tuning apparatus 10. In other examples, the output of the first phase sensitive detector 50 may be used differently, for example as an input to further electronic components.

In the example of FIG. 2, a piezoelectric transducer 64 provides mechanical fine adjustment of the length of the cavity 36 via a mechanical connection 66 to the second mirror 44. This eliminates the need to precisely control the length of the cavity 36 during manufacture. In other examples in which the mode of the cavity is locked to the carrier frequency of the frequency-modulated laser beam, the length of the cavity 36 may be scanned by a few microns, which for example may be of the order of several free spectral ranges, as will be described further below.

As explained above, at least a portion of the frequency-modulated laser beam 22 may undergo one or more reflections between the first and second mirrors 42, 44. A portion of the frequency-modulated laser beam 22 exits the cavity through the second mirror 44 and second lens 40 and is incident on the first photodetector 46 as described previously. A further portion of the frequency-modulated laser beam 22 is reflected from the second mirror 44 towards the first mirror 42 and exits the cavity 36 through the first mirror 42 and the first lens 38.

The portion of the frequency-modulated laser beam 68 that is reflected back towards the optical arrangement previously described is incident on the quarter-wave plate 34 and then on the second polarising beam splitter 32. The second polarising beam splitter 32 separates the portion of the frequency-modulated laser beam 68 from the incident frequency-modulated laser beam 22 and directs the portion of the frequency-modulated laser beam 68 towards a third mirror 70, which reflects it so it is incident on a second photodetector 72.

The second photodetector 72 converts the portion of the frequency-modulated laser beam 68 into an electrical intensity signal which is indicative of the intensity of the portion of the frequency-modulated laser beam 68. This intensity signal is transferred via an electrical connection 74 to a second phase sensitive detector 76. The second phase sensitive detector 76 operates similarly to the first phase sensitive detector 50, and is also connected to the voltage-controlled oscillator 4 via an electrical connection 78, but is configured to produce a first demodulation signal by demodulating the intensity signal at the modulation frequency. In other examples, the second phase sensitive detector 76 is configured to demodulate the intensity at a frequency other than the modulation frequency, for example a multiple of the modulation frequency or a sum or difference of two frequencies.

The first demodulation signal in this example is indicative of how far the carrier frequency is off resonance with the cavity and can be used as feedback to aid locking of the carrier frequency of the frequency-modulated laser beam 22 and the mode of the cavity to each other. Waves within a cavity having particular frequencies form standing wave patterns; these particular frequencies correspond with the modes of the cavity. Waves with frequencies other than these particular frequencies do not form standing waves; such waves are off-resonance with the cavity. For a cavity with certain cavity modes, the spectroscopic apparatus uses the first demodulation frequency to determine how far the carrier frequency of the frequency-modulated laser beam is off-resonance from a cavity mode. The carrier frequency can then be adjusted accordingly until it corresponds with a mode of the cavity, i.e. until it is on resonance with the cavity such that the laser beam within the cavity forms a standing wave pattern. In other examples, as will be described below, the cavity modes themselves can be adjusted, for example by altering the length of the cavity, until a mode of the cavity corresponds with the carrier frequency of the frequency-modulated laser beam.

In the example of FIG. 2, the first demodulation signal is transferred to a PID (proportional-integral-derivative) controller 80 via an electrical connection 82. The PID controller 80 adjusts the electrical signal provided to the tuning apparatus 10 via an electrical connection 84 in dependence on the difference between the first demodulation signal and the desired carrier frequency of the frequency-modulated laser beam 22. Based on the input signal received by the tuning apparatus 10 from the PID controller 80, the tuning provided to the laser diode 6 is adjusted so as to change the carrier frequency of the frequency-modulated laser beam 22 to a frequency corresponding to a mode of the cavity 36.

In other examples, the signal provided by the PID controller may be used to lock a mode of the cavity to the carrier frequency of the frequency-modulated laser beam. This may be done by supplying the signal from the PID controller to a device that is capable of changing the length of the cavity, for example a piezoelectric transducer drive or a MEMs (microelectromechanical systems) device, to adjust the cavity length until a mode of the cavity corresponds with the carrier frequency of the frequency-modulated laser beam, instead of connecting the PID controller to the tuning apparatus 10. For example, such a device connected to the PID controller may be used instead of the piezoelectric transducer 64 described above. All the examples and various features and options that are described herein in the context of locking the carrier frequency of the frequency-modulated laser beam to a mode of the cavity are also equally applicable to other examples in which a mode of the cavity is locked to the carrier frequency of the frequency-modulated laser beam; such examples shall be taken to be disclosed herein.

Locking the carrier frequency of the frequency-modulated laser beam 22 and the mode of the cavity 36 to each other may be aided by stabilising the linewidth of the frequency-modulated laser beam 22. This may be done, for example, by minimising current noise of the current supplied to the laser diode 6 and/or by minimising mechanical noise or reducing temperature fluctuations of the spectroscopic apparatus 2. In examples, the spectroscopic apparatus can be used to stabilise the frequency of the frequency-modulated laser beam 22 without having to dither the laser beam or the cavity, mechanically or otherwise, for example, without moving the wavelength of the laser beam relative to the cavity resonance. For example, the piezoelectric transducer 64 may be omitted from the spectroscopic apparatus, for example where the cavity length is defined with nanometre precision. In other examples, the spectroscopic apparatus may be used in conjunction with dithering of the laser beam and/or the cavity.

In an example in which the analyte is water vapour, the carrier frequency of the laser beam and/or a mode of the cavity may be locked to for example a wavelength of 1392 nanometres or 1371 nanometres. In other examples, the carrier frequency of the laser beam and/or a mode of the cavity may be locked to any radiative transition of the analyte. The term “radiative transition” in examples refers to an atomic or molecular transition which for example may be associated with a change in the electronic, nuclear, vibrational and/or rotational quantum state of atoms or molecules of the analyte.

In this example, the carrier frequency of the frequency-modulated laser beam and the mode of the cavity are locked to each other at substantially the same time as the output indicative of the amount of the analyte in the mixture is generated. The term “substantially the same time” in examples refers to the locking of the carrier frequency of the frequency-modulated laser beam and the mode of the cavity to each other while the output is generated or at least such that the locking overlaps at least partially with the generating of the output indicative of the amount of the analyte in the mixture. In other examples, the carrier frequency of the frequency-modulated laser beam and the mode of the cavity may be locked to each other at a different time from the generation of the output indicative of the amount of analyte in the mixture.

An example of phase sensitive detection using the spectroscopic apparatus of FIG. 2 will now be described.

With the frequency-modulated laser beam 22 frequency modulated at a modulation frequency ωₘ, a reference signal V_{ref} from the voltage-controlled oscillator 4 and an output signal Vₒᵤₜ, for example a signal obtained by the first or second photodetector 46, 76, are fed into a phase sensitive detector such as the first or second phase sensitive detectors 50, 76 described above. The reference signal V_{ref} and the output signal Vₒᵤₜ in this example are of the form:

V_{ref}(t)=sin(ωₘt)

Vₒᵤₜ(t)=V₀ sin(Ωt+φ)

where V₀ represents the amplitude of the output signal Vₒᵤₜ, Ω is the frequency of the output signal, φ is a relative phase term and Ωt+φ is the instantaneous phase of the output signal.

The phase sensitive detector multiplies the reference and output signals together, resulting in the following signal:

$$\begin{matrix}{V}_{out} ( t ) {V}_{ref} ( t ) = {V}_{0} sin ( Ω t + φ ) sin ( {ω}_{m} t ) \\ = \frac{{V}_{0}}{2} [ cos \{ ( Ω - {ω}_{m} ) t + φ \} - cos \{ ( Ω + {ω}_{m} ) t + φ \} ]\end{matrix}$$

which may be represented more informatively by:

$${V}_{out} ( t ) {V}_{ref} ( t ) = \frac{{V}_{0}}{2} [ cos ( φ ) - cos ( 2 {ω}_{m} t + φ ) ]$$

with Ω set equal to ωₘ.

The result of phase sensitive detection as performed by the phase sensitive detector is to extract only the frequency component of interest by producing a direct current (DC) output at that frequency, and filtering out any signal components not at the desired frequency. Therefore, to demodulate the intensity signal obtained by the second photodetector 76 at the modulation frequency, the reference signal used is of the form V_{ref}=sin(ωₘ t). To demodulate the intensity signal at a higher order harmonic, for example at any given multiple n of the modulation frequency, the reference signal used is of the form V_{ref}=sin(nωₘ t). Therefore, to demodulate the intensity signal obtained by the first photodetector 46 at twice the modulation frequency, the reference signal used is of the form V_{ref}=sin(2ωₘ t). To demodulate the intensity signal at any particular frequency, ωₚ, the reference signal used is of the form V_{ref}=sin(nωₘ t).

The second-order harmonic, in other words the beat signal of interest which oscillates at a frequency of 2ωₘ, is indicative of an amount of an analyte in a mixture in examples. For example, for a given line shape, the 2f signal depends upon the second derivative of the transmission feature. This depends on the shape, for example the width, of the transmission feature. The transmission feature in examples is a given spectral feature of the analyte in the mixture, for example a radiative transition of the analyte. In examples, the shape of the transmission feature depends on the cavity finesse, which depends on the loss of the frequency-modulated laser beam due to absorption by the mixture. For very high frequency modulation, for example, the shape may depend upon the absorption line itself, and hence upon both the magnitude and width of the transmission feature. In other examples, other harmonics of the modulation frequency or other frequencies may provide information on an amount of an analyte in a mixture.

Passing a reference signal of V_{ref}=sin(2ωₘt) through the phase sensitive detector and with an input signal of the form Vₒᵤₜ=V₀ sin(2ωₘt) results in a product signal of Vₒᵤₜ(t)V_{ref}(t)=V₀/2[1−cos(4ωₘt)]. This product signal in examples is transferred to a low-pass filter to remove the high frequency (4ωₘ) term, as the skilled person will appreciate. This therefore extracts the DC component (V₀/2) of this mixed signal. In this example, the extracted DC component corresponds to the second demodulation signal.

The second demodulation signal may be used to generate an output indicative of an amount of an analyte in a mixture. In this example, the extracted DC component, which corresponds to the second demodulation signal, may be transferred to a DC amplifier to amplify the signal of the extracted DC component to generate the output which is indicative of the amount of the analyte in the mixture. The output amplified signal in examples may then be transferred to further electronic components, for example to the front end panel 56 shown in FIG. 2, and/or some other control or data recording equipment in an industrial application for example.

The output amplified DC signal in the example described above is proportional to the amplitude of the second harmonic quadrature component. The resultant output is therefore a DC value representing a single point on the 2ωₘ signal curve.

The first demodulation signal in examples is obtained similarly to the second demodulation signal but using the second phase sensitive detector 76 with a reference signal of the form V_{ref}=sin(ωₘ t) or V_{ref}=sin(ωₚ t) for demodulation at any particular frequency ωₚ.

An example illustration of the principles of operation of a cavity 134 is shown schematically in FIG. 3. This example cavity 134 is a Fabry-Perot etalon. In other examples described in more detail below, a micro-resonator, such as for example a “whispering-gallery-mode” micro-resonator or micro-ring resonator, is used instead of or as well as a linear cavity such as a Fabry-Perot etalon. In yet further examples described in more detail below, plural micro-resonators may be used. As will be appreciated by the skilled person, in other examples, different types of cavity may be used in the spectroscopic apparatus.

In the example of FIG. 3, first and second mirrors 136, 138 reflect a portion of an incident electric field and transmit a further portion of the incident electric field. The electric field outside the cavity 134 at various points is labelled in FIG. 3 from E₁ to E₉. The electric field within the cavity is indicated with the reference numeral 140.

The influence of the cavity 134 upon the output intensity may be determined by considering the interference between transmitted beams with different cavity lifetimes. The incident field enters the example cavity 134 of FIG. 3 with a non-zero angle of incidence to illustrate the principles of reflection and transmission of the electric field incident on the first and second mirrors 136, 138.

In an example of the cavity 134 for use with the spectroscopic method according to embodiments, the electric field is incident on the cavity 134 with a zero angle of incidence and an absorbing analyte is placed within the cavity 134. In this example, the total transmitted field is given by the infinite sum:

$${E}_{T} = {E}_{3} + {E}_{5} + {E}_{7} + … + {E}_{2 n + 1} + …$$

$$where n ∈ ℕ$$

$${E}_{1} = {E}_{0} {e}^{i ( kx - ω t )}$$

$${E}_{2} = {rE}_{1}$$

$${E}_{3} = {t}^{2} {E}_{1} {e}^{i \frac{Δφ}{2} - {δ}_{a}}$$

$${E}_{4} = {rt}^{2} {E}_{1} {e}^{i Δφ - 2 {δ}_{a}}$$

$${E}_{5} = {r}^{2} {t}^{2} {E}_{1} {e}^{i \frac{3 Δφ}{2} - 3 {δ}_{a}}$$

$${E}_{6} = {r}^{3} {t}^{2} {E}_{1} {e}^{2 i Δφ - 4 {δ}_{a}}$$

$${E}_{7} = {r}^{4} {t}^{2} {E}_{1} {e}^{i \frac{5 Δφ}{2} - 5 {δ}_{a}}$$

$$… = …$$

which is given in more compact form by:

$$\begin{matrix}\begin{matrix}{E}_{T} = {E}_{1} {t}^{2} {\sum }_{n = 0}^{∞} {r}^{2 n} {e}^{i \frac{( 2 n + 1 ) Δφ}{2} - ( 2 n + 1 ) {δ}_{a}} \\ = {E}_{1} {t}^{2} \{ {e}^{i \frac{Δ φ}{2} - {δ}_{a}} + {r}^{2} {e}^{i \frac{3 Δφ}{2} - 3 {δ}_{a}} + {r}^{4} {e}^{i \frac{5 Δφ}{2} - 5 {δ}_{a}} + … \} \\ = {E}_{1} {t}^{2} {e}^{i \frac{Δ φ}{2} - {δ}_{a}} \{ 1 + {r}^{2} {e}^{i Δφ - 2 {δ}_{a}} + {r}^{A} {e}^{2 i Δφ - 4 {δ}_{a}} + … \} \\ = {E}_{1} \frac{{t}^{2} {e}^{i \frac{Δφ}{2} - {δ}_{a}}}{1 - {r}^{2} {e}^{i Δφ - 2 {δ}_{a}}} \\ = {E}_{1} \frac{{( 1 - r )}^{2} {e}^{i \frac{Δφ}{2} - {δ}_{a}}}{1 - {r}^{2} {e}^{i Δφ - 2 {δ}_{a}}}\end{matrix} & \\ Δφ = - ( \frac{ω {L}_{I}}{c} + {φ}_{a} ) . & \end{matrix}$$

where r and t are the amplitude coefficients of reflection and transmission respectively, related to the reflectance and transmittance by r²=R and t²=T, Δφ is the overall phase shift over a single traversal of the cavity and δₐ is the amplitude attenuation of the signal caused by the presence of the analyte over the cavity length L.

The overall phase shift Δφ is composed of two frequency dependent phase terms. The first is a transverse mode matching term and the second is the phase shift caused by the presence of the analyte φₐ. The transmitted field, E_{T} divided by the incident field, E₁, results in a new formula for the transmission coefficient, T(ω) of the laser beam passing through the cavity:

$$\frac{{E}_{T}}{{E}_{1}} = T ( ω ) = \frac{( 1 - R ) {e}^{- \frac{1}{2} [ α {L}_{I} + i ( {φ}_{a} + \frac{ω {L}_{I}}{c} ) ]}}{1 - {Re}^{- [ α {L}_{I} + i ( {φ}_{a} + \frac{ω {L}_{I}}{c} ) ]}}$$

where α=δₐ/2L.

The same methods can be applied to obtain the total reflection coefficient, R(ω), in other words by summing the reflected fields numbered 2, 4, 6, 8, . . . , 2n:

$$\frac{{E}_{R}}{{E}_{1}} = R ( ω ) = r - \frac{( 1 - R ) {re}^{- [ α {L}_{I} + i ( {φ}_{a} + \frac{ω {L}_{I}}{c} ) ]}}{1 - {Re}^{- [ α {L}_{I} + i ( {φ}_{a} + \frac{ω {L}_{I}}{c} ) ]}}$$

where α is the absorption coefficient of the analyte and L_{I} is the interaction length, with L_{I} being twice the length of the cavity L and α=δₐ/2L.

The attenuation function δₐ is modelled as a Lorentzian dependent on both the frequency of the laser (ν=ω/2π), total pressure (P_{T}) and temperature (T). The broadening constant (Γ) and line strength (5) can be taken from the HITRAN database (the “high-resolution transmission molecular absorption” database managed by the Harvard-Smithsonian Center for Astrophysics). δₐ is given by:

$${δ}_{a} ( υ ) = \frac{{qP}_{T} SLc}{{k}_{B} T π} \frac{Γ}{( {Γ}^{2} + {( υ - {υ}_{0} )}^{2} )}$$

The symbols in the above equation are defined in the table below, which have been converted to the appropriate units for working in units of Hz.

| Symbol | Description | Units |
|---|---|---|
| q | Volume mixing ratio in ppmᵥ/10⁶ | unitless |
| P_{T} | Total pressure inside the cavity | Pa |
| S | Line strength | m molecule⁻¹ |
| k_{B} | Boltzmann constant | m² kg s⁻² K⁻¹ |
| L | Path length taken by the signal through | m |
| | the sample | |
| T | Temperature | K |
| c | Speed of light in a vacuum | m s⁻¹ |
| Γ | Half width at half maximum (HWHM) | Hz |
| | of the Lorentzian profile | |

The relationship between the attenuation function δₐ(ν) and the dispersion function φₐ(ν) is given by the Kramers-Kronig relation:

$$n ( v ) = 1 + \frac{c}{π} {\int }_{0}^{∞} \frac{α ( {v}^{′} )}{{v}^{′2} - {v}^{2}} {dv}^{′}$$

where n(ν) is the refractive index and α(ν)=δₐ(ν)/2L, and where n(ν) is related to φₐ((ν) by:

$${φ}_{a} ( v ) = \frac{4 π vn ( v ) L}{c}$$

For the purposes of illustration, in this example, the cavity 134 has first and second mirrors 42, 44 with a radius of curvature of 250 millimetres (mm) and a diameter of 12.7 mm. With a refractive index of 2 and a length of 0.25 metres (m), this gives a free spectral range, FSR, defined as:

$$F S R = \frac{c}{2 nL}$$

of 600 megahertz (MHz), where c is the speed of light, n is the refractive index of the medium within the cavity and L is the length of the cavity. The corresponding bandwidth is FSR/F, where F is the finesse, which may be viewed as a measure of the resolving power of an optical resonator such as the cavity. In this example, the reflectivity limited finesse F of the cavity is 10,000. Therefore, the bandwidth, or full width at half maximum, is 60 kHz. To couple the laser beam into this example cavity, the laser line width should be reduced to be of the order of tens of kHz. This may be achieved, for example, by a combination of temperature, current and mechanical stabilisation.

A resonator or cavity's ability to store energy is given by its quality factor, Q. This is 2π times the ratio of the energy stored in the resonator to the energy dissipated per oscillation cycle:

$$\begin{matrix}Q = 2 π \times \frac{{U}_{stored}}{{U}_{loss / cycle}} \\ = 2 π \times \frac{{U}_{stored}}{- ( dU / dt ) \cdot {τ}_{cycle}} \\ = 2 π {v}_{0} \times \frac{{U}_{stored}}{Power loss} ,\end{matrix}$$

where ν₀ is the resonance frequency.

The field at a given time in a lossy cavity is given by:

E(t)=E₀ cos(ω₀t)e^{-γt}

such that the energy is proportional to e^{-γt} and the power loss is proportional to γe^{-γt}. Given that the Fourier transform of a two-sided decaying exponential is a Lorentzian with full-width, half-maximum (FWHM) equal to 2γ, substituting for U_{stored} and power loss in the definition for Q gives:

$$Q = \frac{{v}_{0}}{{δ}_{v}}$$

where δν is the half-power bandwidth, i.e. the bandwidth over which the power is greater than half the power at the resonant frequency ν₀.

It follows that the Q factor is directly proportional to the cavity finesse, F, via:

$$F = \frac{F S R}{δ v} = \frac{F S R}{{v}_{0}} \cdot \frac{{v}_{0}}{δ v} = \frac{F S R}{{v}_{0}} \cdot Q$$

An example linear cavity finesse in the reflectivity limiting regime with a finesse of 10,000, which corresponds to mirror reflectivities of 0.99969, a cavity length of 0.25 m and resonance frequency of 1.4 μm, will result in a quality factor of 3.6×10⁹. This is a high quality factor for a mechanical cavity but may be exceeded by using ultra high reflectivity mirrors, or micro-resonators. Micro-resonators have Q factors that may be two or more orders of magnitude higher than a linear cavity incorporating some of the most reflective mirrors currently available.

Returning to the example cavity 134 of FIG. 3, substitution of the net transmission given by:

$$\frac{{E}_{T}}{{E}_{1}} = T ( ω ) = \frac{( 1 - R ) {e}^{- \frac{1}{2} [ α {L}_{I} + i ( {φ}_{a} + \frac{ω {L}_{I}}{c} ) ]}}{1 - {Re}^{- [ α {L}_{I} + i ( {φ}_{a} + \frac{ω {L}_{I}}{c} ) ]}}$$

into the equation representing the frequency-modulated intensity signal:

$$I ( t ) = {I}_{0} \{ \frac{{β}^{2}}{4} {T}_{- 1} {T}_{- 1}^{*} + {T}_{0} {T}_{0}^{*} + \frac{{β}^{2}}{4} {T}_{1} {T}_{1}^{*} + 2 Re ( α ) cos ( {ω}_{m} t ) - 2 Im ( α ) sin ( {ω}_{m} t ) + 2 Re ( γ ) cos ( 2 {ω}_{m} t ) - 2 Im ( γ ) sin ( 2 {ω}_{m} t ) \}$$

leads to a frequency-modulated cavity-enhanced absorption spectroscopy signal. Subsequent algebraic manipulation provides a form for the second harmonic quadrature signal (sin(2ωₘ) component):

$$\frac{1}{4} ( {R}^{2} - 1 ) β \times \{ ( - \frac{\begin{matrix}2 M ( c cos ( ψ ) ( 1 - R + {RL}_{I} ( {α}_{- 1} + {α}_{0} ) ) + \\ R sin ( ψ ) ( - c {φ}_{- 1} + c {φ}_{0} + {L}_{I} {ω}_{m} ) )\end{matrix}}{\begin{matrix}R ( {c}^{2} ( {( R - 1 )}^{2} + {{R}^{2} ( {φ}_{- 1} - {φ}_{0} )}^{2} ) + 2 {cRL}_{I} ( - c ( R - 1 ) ( {α}_{- 1} + {α}_{0} ) + \\ R ( - {φ}_{- 1} + {φ}_{0} ) {ω}_{m} ) + {R}^{2} {L}_{I}^{2} ( {{c}^{2} ( {α}_{- 1} + {α}_{0} )}^{2} + {w}_{m}^{2} ) )\end{matrix}} + \frac{\begin{matrix}2 M ( c cos ( ψ ) ( 1 - R + {RL}_{I} ( {α}_{0} + {α}_{1} ) ) + \\ R sin ( ψ ) ( - c {φ}_{0} + c {φ}_{1} + {L}_{I} {ω}_{m} ) )\end{matrix}}{\begin{matrix}R ( {c}^{2} ( {( R - 1 )}^{2} + {{R}^{2} ( {φ}_{0} - {φ}_{1} )}^{2} ) + 2 {cRL}_{I} ( - c ( R - 1 ) ( {α}_{0} + {α}_{1} ) + \\ R ( - {φ}_{0} + {φ}_{1} ) {ω}_{m} ) + {R}^{2} {L}_{I}^{2} ( {{c}^{2} ( {α}_{0} + {α}_{1} )}^{2} + {ω}_{m}^{2} ) )\end{matrix}} + \frac{β ( c {φ}_{- 1} - c {φ}_{1} - 2 {L}_{I} {ω}_{m} )}{\begin{matrix}{c}^{2} ( {( R - 1 )}^{2} + {{R}^{2} ( {φ}_{- 1} - {φ}_{1} )}^{2} ) + 2 {cRL}_{I} ( - c ( R - 1 ) ( {α}_{- 1} + {α}_{1} ) + \\ 2 R ( - {φ}_{- 1} + {φ}_{1} ) {ω}_{m} ) + {R}^{2} {L}_{I}^{2} ( {{c}^{2} ( {α}_{- 1} + {α}_{1} )}^{2} + 4 {ω}_{m}^{2} )\end{matrix}} \}$$

Therefore, at a given frequency, the second harmonic quadrature signal is proportional to a product of β, absorption, finesse and cavity length, where β is inversely proportional to the modulation frequency ωₘ. This may be expressed as a product of the absorption and the ratio of the modulation frequency to the cavity linewidth, where the cavity linewidth is equal to the free spectral range divided by the finesse.

The height of this signal is dependent on analyte concentration. In the case of straight frequency modulation-amplitude modulation, it can be seen from the model given below:

$$I ( t ) \approx {I}_{0} \{ \frac{{β}^{2}}{4} {T}_{- 1} {T}_{- 1}^{*} + {T}_{0} {T}_{0}^{*} + \frac{{β}^{2}}{4} {T}_{1} {T}_{1}^{*} + [ β ( {δ}_{- 1} - {δ}_{1} ) + 2 M ( 1 - 2 {δ}_{0} ) sin ( ψ ) ] cos ( {ω}_{m} t ) - [ β ( 2 {φ}_{0} - {φ}_{- 1} - {φ}_{1} ) - 2 M ( 1 - 2 {δ}_{0} ) cos ( ψ ) ] sin ( {ω}_{m} t ) + 2 [ \frac{M β}{2} ( {δ}_{- 1} - {δ}_{1} ) sin ( ψ ) - \frac{{β}^{2}}{4} ( 1 - {δ}_{1} - {δ}_{- 1} ) + \frac{M β}{2} cos ( ψ ) ( 2 {φ}_{0} - {φ}_{1} - {φ}_{- 1} ) ] cos ( 2 {ω}_{m} t ) - 2 [ \frac{M β}{2} ( 2 {φ}_{0} - {φ}_{1} - {φ}_{- 1} ) sin ( ψ ) - \frac{{β}^{2}}{4} ( {φ}_{- 1} - {φ}_{1} ) + \frac{M β}{2} ( {δ}_{1} - {δ}_{- 1} ) cos ( ψ ) ] sin ( 2 {ω}_{m} t ) \} .$$

that this signal is directly proportional to the dispersion, φ₁, at frequency ν₀+νₘ.

A second method of determining the cavity enhanced 2f-signal is to use the equivalent interaction length

$${L}_{eq} = \frac{2}{π} FL ,$$

which scales the intensity of the 2f signal by a factor of 2F/π˜6300, as described in Gianfrani L. et al., “Cavity-enhanced absorption spectroscopy of molecular oxygen”, J. Opt. Soc. Am. b, 16(12):2247-2254, 1999, which is herein incorporated by reference.

The sensitivity of detecting optical absorption by molecular species may be facilitated by enhancing the absorption signal and/or reducing the background noise, ideally to the fundamental quantum limit. Ultimate detection sensitivity is achieved when the absorption event is merely obscured by the inherent uncertainty associated with excitation, known as the “shot noise” in the signal. This type of noise is due to the discrete nature of electrons and photons that are created at various points during the detection scheme. This statistical nature is due to random fluctuations in the generation of free electrons during matter-photon interactions at the detector, termed “light current”, as well as random thermionic emission, termed “dark current”. Such statistical fluctuations are Poissonian in nature. In the high light limit, as is the case for an absorption application for example, only photon contributions to the shot noise will need to be considered. Beer-Lambert's law states that any interrogating light passing through an analyte sample of length L will be attenuated by the factor e^{αL}. Attenuation of the input signal is quantum mechanical in origin and, for molecular spectroscopy, arises due to activating driven dipole moments at the input frequency, resulting in dipole radiation at that same frequency which interferes destructively with the initial field.

Direct absorption at a given frequency is known as homodyne detection and has a maximum sensitivity given by its shot noise limit:

$${( α L )}_{min} = {( \frac{2 eB}{η {P}_{0}} )}^{1 / 2}$$

where e, B, η and P₀ are electron charge, detection bandwidth, photodetector responsivity and incident power respectively

Direct absorption spectroscopy typically detects absorbances in the 10⁻²-10⁻³ range. The drawback of this simple technique is that its sensitivity is often limited by low frequency noise in the signal. Low frequency contributions to the background signal in an example may be a combination of laser intensity noise, mechanical instabilities and other external fluctuations. This noise may be referred to as 1/f (or flicker) noise due to the inverse relationship of its power spectrum with respect to frequency. High 1/f noise contributions may be circumvented by switching to detection methods that omit low frequency contributions and focus on higher frequency detection, such as the beat frequencies detected using frequency modulation spectroscopy, as described above.

For straight frequency modulation, the corresponding minimum detectable absorption in examples is given by:

$${( α L )}_{min} = {( \frac{2 eB}{η {P}_{0}} )}^{1 / 2} \frac{\sqrt{2}}{{J}_{0} ( β ) {J}_{1} ( β )}$$

For a small modulation index, this value can be greater than that given by the shot noise limit above. However, this may be accompanied by an increase in signal to noise ratio due to avoidance of the large contribution of low frequency noise.

In examples, sensitivity may be improved via the use of an optical cavity, as discussed above. When the cavity enhancement effect only applies to the signal, the sensitivity of frequency modulation spectroscopy will typically be improved by a cavity enhancement factor of π/2F. Hence, the shot noise limit for frequency modulated cavity-enhanced absorption spectroscopy is given by:

$${( α L )}_{min} = \frac{π}{2 F} {( \frac{2 eB}{η {P}_{T}} )}^{1 / 2} \frac{\sqrt{2}}{{J}_{0} ( β ) {J}_{1} ( β )}$$

However, as will be appreciated by the skilled person, in other examples the spectroscopic apparatus may not comprise a cavity. For example, the optical path length may be increased using folded optical lines, for example using a Herriott cell. In examples, the method according to examples may be used to lock the carrier frequency of the frequency-modulated laser beam to a desired frequency instead of to a mode of the cavity. For example, the desired frequency may correspond to a radiative transition of the analyte.

In further examples of the spectroscopic method according to embodiments, a so-called “zero-reading” may be used for calibration purposes. The zero-reading is representative of the absorption of the laser beam due to components of the mixture other than the analyte. In examples, the zero-reading may be performed before or after the spectroscopic method for determining the amount of analyte in a mixture. For example, by subtracting the zero-reading from the output generated on the basis of the second demodulation signal, the contribution of the analyte itself, excluding the contribution from other absorbing components of the mixture, can be extracted.

In examples, the zero-reading measurement is obtained by locking the carrier frequency of the frequency-modulated laser beam to a frequency at which substantially none of the frequency-modulated laser beam is absorbed by the analyte when the frequency-modulated laser beam interacts with the mixture. The term “substantially none” in examples refers to absorption of the frequency-modulated laser beam by the analyte at a level which is insignificant or negligible with respect to absorption of the frequency-modulated laser beam by other components of the mixture. A second intensity signal indicative of an interaction between the frequency-modulated laser beam with this carrier frequency and the mixture is demodulated to obtain a third demodulation signal. The second intensity signal may be demodulated at a multiple of the modulation frequency, which may be an exact or integer multiple (for example at twice the modulation frequency) or a non-exact or non-integer multiple. The third demodulation signal is used to generate an output indicative of an amount of the frequency-modulated laser beam which is absorbed by one or more components of the mixture other than the analyte, for example using the method described above with reference to production of the first and second demodulation signals.

In an example, the zero-reading measurement is obtained by locking the carrier frequency of the frequency modulated laser beam onto a cavity mode outside a spectral feature of the analyte of interest, where for example the spectral feature may be a radiative transition, in a region where the linestrength, S, is around 7-10 orders of magnitude lower to provide a baseline value. The tunability of a typical laser diode is around 0.1-0.2 nanometres per Kelvin, so the presence of a nearby region of low-absorption, for example within a few nanometres of the spectral feature, is desirable. This keeps the detuning temperature close to the operating temperature, thereby reducing the time between zero-readings and returning to the spectral feature.

Detuning of the carrier frequency by a similar magnitude can also be achieved using an etalon placed between the frequency-modulated laser beam and the cavity housing the analyte. In an example, rotation of a planar Fabry-Perot etalon allows more rapid and controlled wavelength adjustment of the transmission maximum compared to temperature detuning.

The use of multiple frequency modulation and higher harmonic detection can be incorporated to extend the dynamic range of the apparatus. Extension to two-tone modulation (or higher) has benefits with regards to the amount of information on the overall lineshape that becomes accessible. Modulating the carrier signal with a range of frequencies in examples produces a complex pseudorandom signal. In examples, use of a pseudorandom modulation signal corresponds to modulating the carrier frequency of the frequency modulated laser beam simultaneously with a range of modulation frequencies. Using digital electronics, this may provide a higher degree of discrepancy between outputs on measurements of different analyte concentration.

In an example spectroscopic apparatus according to embodiments, the photodetector measures a frequency dependent voltage:

V(ω)=V(r(t))=V(ω_{c}+β sin(ωₘt))

where r(t)=ω_{c}+β sin(ωₘ t) is the system's response function.

This signal V(ω) may also be written as a Taylor series expansion:

$$V ( ω ) = V ( {ω}_{c} ) + \frac{β}{2 !} \frac{dV}{d ω} {\vert}_{{ω}_{c}} sin ( {ω}_{m} t ) + \frac{{β}^{2}}{2 !} \frac{{d}^{2} V}{d {ω}^{2}} {\vert}_{{ω}_{c}} {sin}^{2} ( {ω}_{m} t ) + \frac{{β}^{3}}{3 !} \frac{{d}^{3} V}{d {ω}^{3}} {\vert}_{{ω}_{c}} {sin}^{3} ( {ω}_{m} t ) + … = [ V ( {ω}_{c} ) + \frac{{β}^{2}}{4} \frac{{d}^{2} V}{d {ω}^{2}} {\vert}_{{ω}_{c}} + … ] + sin ( {ω}_{m} t ) [ β \frac{dV}{d ω} {\vert}_{{ω}_{c}} + \frac{{β}^{3} {sin}^{2} ( {ω}_{m} t )}{6} \frac{{d}^{3} V}{d {ω}^{3}} {\vert}_{{ω}_{c}} + … ] + cos ( 2 {ω}_{m} ) [ - \frac{{β}_{2}}{4} \frac{{d}^{2} V}{d {ω}^{2}} {\vert}_{{ω}_{c}} + … ] + …$$

Using a phase sensitive detector, any DC term will be blocked by the capacitor and an nth harmonic term can be detected using phase sensitive detection. The expression for V(ω) as a Taylor series expansion shows the potential for a detailed determination of the lineshape of a given spectral feature. In an example, the DC term (0f term) provides an estimation to a first order of the spectral feature magnitude at the carrier frequency. The 1f term provides an estimate of the derivative of the feature at the carrier frequency and the 2f term provides information on the second derivative and thus the curvature of the feature at the carrier frequency. At low modulation frequencies this would give information on the structure of the transmission signal, and hence of any change in cavity finesse. At higher modulation frequencies, and at some multiple of the FSR, this provides the possibility of spread spectrum techniques to determine the structure of a molecular absorption feature. For example, the 2f signal will give more information about the feature curvature over the three mode transmission where νₘ=FSR, compared to that obtained at a lower modulation frequency.

If phase sensitive detection is carried out at multiple orders from 0f to nf, where n is an integer and may for example be limited by electronic detection capability, there is the potential to predict the form of the spectral feature's function. The accuracy of the estimation will increase with n, but will also be limited by the detection sensitivity at the higher order harmonics as the modulation depth β has a value β≦1.

Data acquisition incorporating the spread-spectrum techniques of multiple frequency modulation and higher harmonic detection may also lead to more sensitive information on changes in other parameters such as, temperature and pressure. These techniques may also provide a more efficient means of obtaining a zero calibration.

Spread-spectrum techniques increase the bandwidth of the carrier frequency of the frequency-modulated laser beam. In examples, this provides a detected intensity signal comprising more information on an absorption feature and therefore providing a more exhaustive method of signal analysis. A spread-spectrum technique according to an example includes frequency modulating a laser beam at a plurality of modulation frequencies to generate a frequency-modulated laser beam. Frequency-spreading can be enabled for example by using a pseudo-random noise generator to generate the frequency-modulated laser beam. This may be done in conjunction with phase-shift keying of the carrier frequency of the frequency-modulated laser beam, for example. This is an example of “frequency hopping”, in which the carrier frequency of the frequency-modulated laser beam is switched between multiple different frequency channels using a pseudo-random sequence. In an example, this is equivalent to replacing a sinusoidal modulation function with a more complicated modulating function M(t); such a function may be represented by a finite Fourier summation for example.

The increase in complexity of the modulation signal when using spread spectrum techniques according to examples provides greater choice when demodulating the intensity signal. In an example, the intensity signal is demodulated at each of the plurality of modulation frequencies. In other examples, the intensity signal may be demodulated at one or more other frequencies other than the plurality of modulation frequencies. If the range of frequencies over which the carrier frequency of the laser beam is modulated is of the order of the width of a spectral feature of the analyte, for example of the order of the width of a radiative transition of the analyte or the mode of the resonant cavity, demodulation of the intensity signal over this range of frequencies provides the derivative of the spectral feature of the analyte at a number of frequencies. Subsequent integration of the demodulated intensity signal over a range of frequencies can be used to predict the shape of the cavity mode, for example, the shape of the cavity resonance as a function of frequency. In examples, this provides more information and suffers less from background noise effects than demodulation at multiple orders of harmonics for a single modulation frequency due to this information being obtained at the same modulation order.

In examples, the non-linearity of the cavity resonance will lead to the generation of higher order harmonics at a given modulation frequency. Thus, examples of the spectroscopic method include producing one or more further demodulation signals by demodulating the intensity signal at one or more further frequencies. For example, for a sinusoidal input, information on higher order harmonics may be obtained by demodulating the intensity signal at these higher order frequencies and obtaining the Fourier coefficients of each of the higher order components. The one or more further frequencies are an integer multiple of the modulation frequency in examples, though they may not be in other examples. For example, in examples where the laser beam is modulated by a plurality of modulation frequencies, the one or more further frequencies may be a sum or a beat (difference) frequency of two or more of the plurality of modulation frequencies. In examples, the one or more further frequencies are each more than twice the modulation frequency. However, in other examples, the one or more further frequencies may be lower than the modulation frequency.

In some cases, saturation of the mixture by the analyte may limit the effectiveness of the spectroscopic method according to embodiments. In examples, for example where the concentration of the analyte in the mixture is relatively high, there are one or more carrier frequencies for which a negligible proportion of the frequency-modulated laser beam passes through the mixture due to saturation by the analyte. Therefore, for these one or more carrier frequencies, the intensity signal obtained after passing the frequency-modulated laser beam through the mixture may be small or negligible. This may be addressed in examples by taking the laser line off-centre of the absorption signal, for example using one or more of current and temperature tuning, until a relatively strong transmission is observed, and then using the spectroscopic method according to examples to measure the amount of the analyte. For example, the laser frequency may be tuned away from the cavity mode positioned closest to the centre of the absorption profile and may instead be coupled into an adjacent or other mode outside the zero-signal bandwidth in which saturation occurs. The spectroscopic method may also or alternatively include locking the mode of the cavity to a mode with a frequency which is away from the cavity mode at the centre of the absorption profile.

In an example spectroscopic apparatus including a resonator with a large free spectral range such as a micro-resonator, a resonator with a resonance in the tails of an atomic or molecular lineshape may be selected to reduce saturation effects. The level of saturation of the field of the frequency-modulated laser beam can be exploited to detect different analyte concentrations. For example, if the evanescent field produced with a micro-resonator is intense, then it will be more suitable for the detection of high analyte concentrations as saturation of the evanescent field is unlikely. Saturation effects, may also or alternatively be reduced by using multiple laser sources of different carrier frequencies can be used with a scanning cavity with a broad range mirror reflectivity to detect different analytes.

The cavity of the apparatus described above with reference to FIG. 2 and FIG. 3 is a hollow cavity which contains the mixture in use. However, in other arrangements, cavities that do not contain the mixture in use but which nevertheless still increase the intensity of the signal by increasing the effective path length of the laser beam may be used. As an example, so-called micro-resonators, which typically but not necessarily are solid, may be used in the apparatus to increase the intensity of the frequency-modulated laser beam and thereby increase the intensity of the output that is indicative of the amount of the analyte in the mixture. For example, the intensity of the frequency-modulated laser beam may be increased by coupling an incident field from the frequency-modulated laser beam into a micro-resonator using, for example, an evanescent field. In examples, the frequency-modulated laser beam undergoes constructive interference within the micro-resonator, thereby increasing its intensity. An evanescent field is produced where the frequency-modulated laser beam is incident on a boundary between the micro-resonator and an external environment having a different refractive index, and extends outside the micro-resonator in examples. In such examples, the mixture may be close enough to the evanescent field that the evanescent field interacts with the mixture. For example, the mixture may be adjacent to, for example in contact with, the micro-resonator. The amount of the analyte in the mixture may affect the angle of total internal reflection of the frequency-modulated laser beam within the micro-resonator at the boundary between the micro-resonator and an external environment, which can affect losses in the system, for example via the evanescent field. The frequency-modulated laser beam can then be coupled out of the micro-resonator and detected using a photodetector and demodulated to obtain the output indicative of the amount of the analyte in the mixture, as described below. In examples, sensitivity can be optimised by using a micro-resonator in isolation. However, in other examples, a micro-resonator may be embedded within a layer of another material, which may be a thin layer.

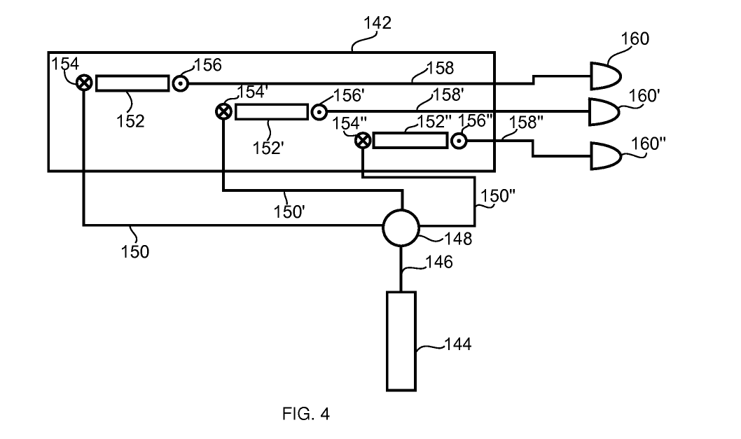

In further examples, two or more parallel micro-resonators with different degrees of coupling may be used to provide different levels of sensitivity. Such an example is shown schematically in FIG. 4, in which three micro-resonators are used. In the example of FIG. 4, a mixture (not shown) comprising an analyte is provided in a container 142. A laser source 144 generates a frequency-modulated laser beam 146 which is split by a beam splitter 148 into first, second and third further frequency-modulated laser beams 150, 150′, 150″. The first further frequency-modulated laser beam 150 is incident on a first micro-resonator 152 and is coupled into the first micro-resonator 152 via an input coupler 154. An output coupler 156 couples a portion 158 of the first further frequency-modulated laser beam 150 out of the first micro-resonator 152. The second and third frequency-modulated laser beams 150′, 150″ are coupled into second and third micro-resonators 152′, 152″ respectively. Components of the second and third micro-resonators 152′, 152″ which are similar to corresponding components of the first micro-resonator 152 are denoted with the same reference numerals but with a single dash for the second micro-resonator 152′ and with a double dash for the third micro-resonator 152″. First, second and third portions 158, 158′, 158″ of the first, second and third further frequency-modulated laser beams 150, 150′, 150″ exit the first, second and third micro-resonators 152, 152′, 152″ and are incident on first, second and third photodetectors 160, 160′, 160″. The photodetectors 160, 160′, 160″ convert the first, second and third portions 158, 158′, 158″ into intensity signals indicative of their relative intensities and thus of the amount of the analyte at the relative positions of the first, second and third micro-resonators 152, 152′, 152″.

Implementing multiple micro-resonators at once in examples allows broad range measurements to be carried out without physically tuning the system. Saturation may be circumvented, for example, by placing micro-resonators, for example micro-ring resonators, at various depths in a substrate, for example at different distances from the mixture, such that at least one gives a detectable transmission signal. In examples, the frequency-modulated laser beam incident on a micro-resonator further from the mixture loses energy via absorption of the evanescent field but is not saturated. In contrast, the frequency-modulated laser beam incident on a micro-resonator which is closer to the mixture may suffer from saturation.

In other examples, a plurality of cavities, each containing the mixture, may be used in a similar way to the above-described example using micro-resonators to reduce saturation effects.

In further examples in which a waveguide is used, a row of resonators or cavities, each at the same depth within a mixture and each at a different distance to an input coupler can be used to reduce saturation effects.

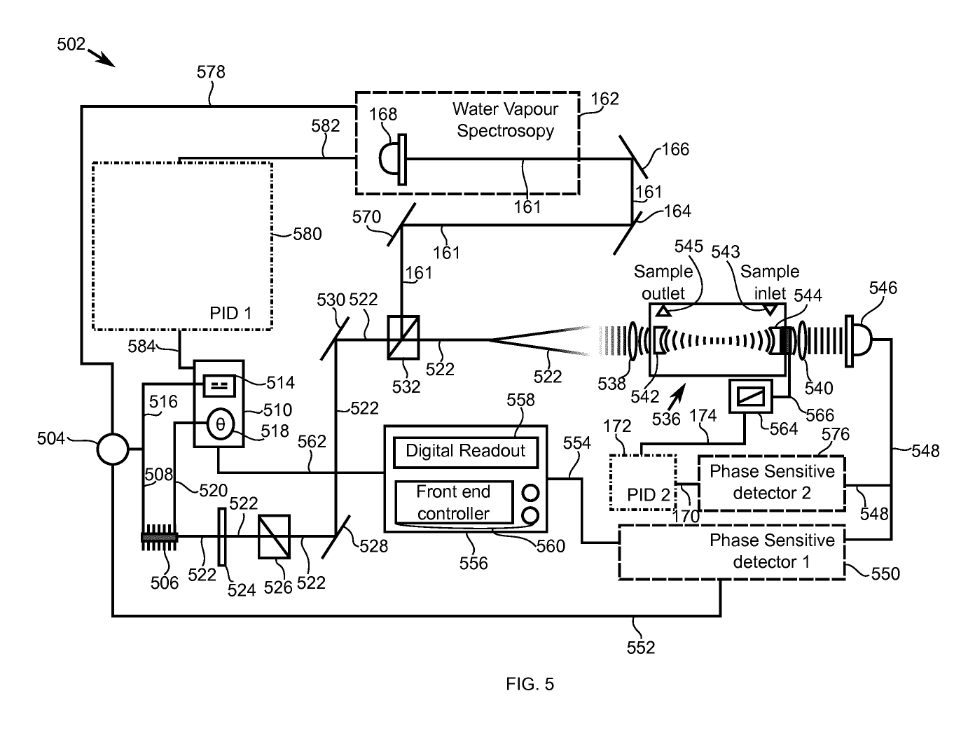

A schematic illustration of an example spectroscopic apparatus for measuring an amount of an analyte in a mixture according to a further embodiment is shown in FIG. 5. Features of FIG. 5 similar to those described with reference to FIG. 2 are referred to using the same reference numerals as FIG. 2 but incremented by 500; corresponding descriptions should be taken to apply also.

The spectroscopic apparatus 502 of FIG. 5 is similar to the spectroscopic apparatus 2 of FIG. 2, but additionally includes a laser locking arrangement 162 for locking the carrier frequency of the frequency-modulated laser beam 522 to a spectral feature of the analyte, such as a frequency of a radiative transition of the analyte. (In this case, water is the analyte, though in general the apparatus 2, 502 may be used with other analytes, as mentioned above.) If there is for example a variation in driving current or temperature of the laser source 506, the carrier frequency of the frequency-modulated laser beam 522 may drift away from a given frequency that correspond to the radiative transition of the analyte, which may be incorrectly treated or misinterpreted as a change in analyte concentration. Thus, locking the carrier frequency of the frequency-modulated laser beam 522 to the radiative transition of the analyte using a laser locking arrangement such as that of FIG. 5 improves the accuracy of the analyte concentration measurement and reduces the likelihood of obtaining an incorrect measurement of the analyte concentration due to drift of the carrier frequency of the frequency-modulated laser beam 522 in examples.

In FIG. 5, the frequency-modulated laser beam 522 incident on the beam splitter 532 is split. A portion of the frequency-modulated laser beam 522 is incident on the cavity, similarly to the FIG. 2 example, and a portion of the frequency-modulated laser beam 161 is directed towards the laser locking arrangement 162 for locking the frequency-modulated laser beam 522 to a spectral feature of the analyte, via mirrors 570, 164, 166, rather than towards a second phase sensitive detector as in the embodiment of FIG. 2.

The laser locking arrangement 162 of FIG. 5 includes an acousto-optical modulator (AOM) (not shown), although other apparatus is used in other examples. As is known per se, an AOM includes a crystal through which an acoustic travelling wave is passed, creating a sinusoidally varying refractive index. In the present example, the portion of the frequency-modulated laser beam 568 is passed through the crystal, orthogonally to the acoustic travelling wave, which causes the portion of the frequency-modulated laser beam 568 to be diffracted into several orders. These orders are separated in both angle and frequency at multiples of the sum of the optical and acoustic wavevectors, in other words the sum of the wavevectors of the portion of the frequency modulated laser beam 568 and the acoustic travelling wave respectively. AOMs typically operate with acoustic frequencies varying from 10 MHz to 1 GHz. An error signal for laser stabilisation is obtained by passing two diffraction orders of the portion of the frequency-modulated laser beam 568 through a cell containing a reference sample of the analyte, in this case a cell containing water vapour (although the ambient humidity could also be used in other examples in which the analyte is water). The reference sample of the analyte in examples is or includes the mixture for which the amount of analyte is measured, for example where the mixture is an ambient mixture. In other examples, the reference sample of the analyte is separate from the mixture. The reference sample of the analyte may include components other than the analyte and may itself be a mixture. The difference in absorption spectra between diffracted orders is obtained using a photodiode 168 (although a quadrant photodetector or balanced detector may additionally or alternatively used). This involves obtaining two frequency-separated absorption features that, when subtracted from one another, creates a “dispersion shaped” error signal. Using the zeroth and first diffraction orders, the zero point is exactly at half the modulation frequency. For example, with the AOM in the Raman-Nath regime, using the −1^{st} and +1^{st} orders the zero is exactly on resonance.

The error signal obtained in this way is indicative of how far the frequency-modulated laser beam is off resonance from the frequency of the spectral feature of the analyte. In examples such as that of FIG. 5, this error signal is transferred to a first PID controller 580 via an electrical connection 582. Similarly to the PID controller 80 of FIG. 2, the first PID controller 580 of FIG. 5 adjusts the electrical signal provided to the tuning apparatus 510 via an electrical connection 584 in dependence on the error signal, to alter the tuning provided to the laser diode 506 so as to change the carrier frequency of the frequency-modulated laser beam 522 to more closely match the frequency of the spectral feature of the analyte.

Using AOMs for obtaining the error signal, for example as described with reference to FIG. 5, can remove or reduce a dependence of the spectroscopy on specific molecular properties of the analyte, without imposing additional modulation frequencies on the zeroth order laser beam. Balanced detection, for example of the difference in absorption spectra between different diffracted orders of the portion of the frequency-modulated laser beam 568 as described above, also reduces common mode (intensity) noise in examples.

In the example of FIG. 5, the first photodetector 546 receives a portion of the frequency-modulated laser beam 522 that has exited the cavity 536 through the second mirror 544 and the second lens 540 and converts the incident portion of the frequency-modulated laser beam 522 into an intensity signal which is indicative of an interaction between the frequency-modulated laser beam 522 and the mixture, similarly to FIG. 2. However, in FIG. 5, the intensity signal, which is an electronic signal in this example, is transferred via an electrical connection 548 to both the first phase sensitive detector 550 (which operates similarly to FIG. 2), and the second phase sensitive detector 576. The second phase sensitive detector 576 of FIG. 5 operates similarly to the second phase sensitive detector 76 of FIG. 2 and is configured to produce a first demodulation signal by demodulating the intensity signal at the modulation frequency. The first demodulation signal is transferred to a second PID controller 172 via an electrical connection 170. The second PID controller 172 of FIG. 5 adjusts the electrical signal provided to the piezoelectric transducer 564 via an electrical connection 174. The piezoelectric transducer 564, in response, provides a mechanical fine adjustment of the length of the cavity 536 via a mechanical connection 566 to the second mirror 544 to lock the length of the cavity 536 to a mode of the cavity that has a frequency which is closest to the carrier frequency of the frequency-modulated laser beam 522 based on the first demodulation signal. Thus, the example of FIG. 5 involves both locking the carrier frequency of the frequency-modulated laser beam to a frequency of a radiative transition of an analyte and locking the cavity to a mode with a frequency closest to the carrier frequency of the frequency-modulated laser beam.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An apparatus for measuring an amount of an analyte in a mixture, the apparatus comprising:
a laser source for generating a frequency-modulated laser beam which is frequency modulated at a modulation frequency or at a plurality of modulation frequencies;
a cavity arranged to receive the frequency-modulated laser beam;
a photodetector for obtaining an intensity signal indicative of an interaction between the frequency-modulated laser beam and the mixture;
a first demodulator for producing a first demodulation signal by demodulating the intensity signal;
a frequency locking arrangement arranged to use the first demodulation signal to lock a carrier frequency of the frequency-modulated laser beam and a mode of the cavity to each other; and
a second demodulator for producing a second demodulation signal by demodulating the intensity signal and for generating, on the basis of the second demodulation signal, an output indicative of the amount of the analyte in the mixture.

2. An apparatus according to claim 1, arranged such that the laser beam is frequency modulated at a modulation frequency and wherein the first demodulator is arranged to produce the first demodulation signal by demodulating the intensity signal at the modulation frequency.

3. An apparatus according to claim 1, arranged such that the laser beam is frequency modulated at a modulation frequency and wherein the second demodulator is arranged to produce the second demodulation signal by demodulating the intensity signal at a multiple of the modulation frequency.

4. An apparatus according to claim 3, wherein the second demodulator is arranged to produce the second demodulation signal by demodulating the intensity signal at twice the modulation frequency.

5. (canceled)

6. (canceled)

7. An apparatus according to claim 1, wherein the frequency locking arrangement is arranged to lock at least one of (i) the carrier frequency of the frequency modulated laser beam and (ii) the mode of the cavity to a mode of the cavity that has a frequency which is closest to a frequency of a radiative transition of the analyte.

8. An apparatus according to claim 1, wherein the frequency locking arrangement comprises a device for changing a length of the cavity.

9. (canceled)

10. An apparatus according to claim 1, wherein the cavity is provided by a micro-resonator.

11. (canceled)

12. (canceled)

13. (canceled)

14. (canceled)

15. (canceled)

16. (canceled)

17. (canceled)

18. (canceled)

19. A hygrometer comprising an apparatus according to claim 1.

20. A spectroscopic method for measuring an amount of an analyte in a mixture, the method comprising:
generating a frequency-modulated laser beam which is frequency modulated at a modulation frequency or at a plurality of modulation frequencies;
passing the frequency-modulated laser beam into a cavity;
obtaining an intensity signal indicative of an interaction between the frequency-modulated laser beam and the mixture;
producing a first demodulation signal by demodulating the intensity signal;
locking a carrier frequency of the frequency-modulated laser beam and a mode of the cavity to each other using the first demodulation signal;
producing a second demodulation signal by demodulating the intensity signal;
and generating, on the basis of the second demodulation signal, an output indicative of the amount of the analyte in the mixture.

21. A spectroscopic method according to claim 20, wherein the laser beam is frequency modulated at a modulation frequency and the producing the first demodulation signal comprises demodulating the intensity signal at the modulation frequency.

22. A spectroscopic method according to claim 20, wherein the laser beam is frequency modulated at a modulation frequency and the producing the second demodulation signal comprises demodulating the intensity signal at a multiple of the modulation frequency.

23. A spectroscopic method according to claim 22, wherein the producing the second demodulation signal comprises demodulating the intensity signal at twice the modulation frequency.

24. (canceled)

25. (canceled)

26. (canceled)

27. A spectroscopic method according to claim 20, wherein the passing the frequency-modulated laser beam into a cavity comprises passing the frequency-modulated laser beam through a cavity containing the mixture, the obtaining an intensity signal including obtaining an intensity signal indicative of an intensity of the frequency-modulated laser beam having passed through the mixture.

28. (canceled)

29. A spectroscopic method according to claim 20, wherein the locking the carrier frequency of the frequency-modulated laser beam and the mode of the cavity to each other comprises locking at least one of (i) the carrier frequency of the frequency-modulated laser beam and (ii) the mode of the cavity to a mode of the cavity that has a frequency which is closest to a frequency of a radiative transition of the analyte.

30. (canceled)

31. A spectroscopic method according to claim 20, comprising:
locking the carrier frequency of the frequency-modulated laser beam to a frequency at which substantially none of the frequency-modulated laser beam is absorbed by the analyte when the frequency-modulated laser beam interacts with the mixture;
passing the frequency-modulated laser beam into the cavity; obtaining a second intensity signal indicative of an interaction between the frequency-modulated laser beam and the mixture;
producing a third demodulation signal by demodulating the second intensity signal; and
generating, on the basis of the third demodulation signal, an output indicative of an amount of the frequency-modulated laser beam which is absorbed by one or more components of the mixture other than the analyte.

32. (canceled)

33. (canceled)

34. (canceled)

35. (canceled)

36. A spectroscopic method according to claim 20, wherein the analyte comprises water.

37. A spectroscopic method according to claim 20, wherein the analyte comprises one or more of: oxygen, hydrogen fluoride or sulphur dioxide.

38. (canceled)

39. (canceled)

40. (canceled)

41. (canceled)

42. A spectroscopic method according to claim 20, wherein the frequency-modulated laser beam is frequency modulated with a pseudorandom modulation signal so as to frequency modulate the laser beam at a plurality of modulation frequencies.

43. (canceled)

44. (canceled)

45. A spectroscopic method according to claim 20, wherein the frequency-modulated laser beam is frequency modulated at a plurality of modulation frequencies and the intensity signal is demodulated at or a sum or difference of two or more of the plurality of modulation frequencies.

46. A spectroscopic method according to claim 20, wherein the laser beam is frequency modulated at a modulation frequency and the producing the second demodulation signal comprises demodulating the intensity signal at a sum or difference of multiples of the modulation frequency.

47. An apparatus for measuring an amount of an analyte in a mixture, the apparatus comprising:
a laser source for generating a frequency-modulated laser beam which is frequency modulated at a modulation frequency or at a plurality of modulation frequencies;
a cavity arranged to receive the frequency-modulated laser beam so as to provide a frequency-dependent interaction with the laser beam which depends on the cavity finesse;
a photodetector for obtaining an intensity signal indicative of an interaction between the frequency-modulated laser beam and the mixture; and
a demodulator for producing a demodulation signal by demodulating the intensity signal and for generating, through the dependence of the demodulation signal on the frequency response of the cavity to the interaction between the frequency-modulated laser beam and the mixture, an output indicative of the amount of the analyte in the mixture.
